(19) United States
(12) Patent Application Publication
(10) Pub. No.: US 2020/0215956 A1
(43) Pub. Date: Jul. 9, 2020

(54) Revolution Caravan

(71) Applicant: Barry Miller, Doncaster East (AU)

(72) Inventor: Barry Miller, Melbourne (AU)

(21) Appl. No.: 16/729,314

(22) Filed: Dec. 28, 2019

Related U.S. Application Data
(60) Provisional application No. 62/787,957, filed on Jan. 3, 2019.

(51) Int. Cl. B60P 3/34; B62D 21/11; B62D 21/09; B62D 21/02

(52) U.S. Cl. CPC B60P 3/34; B62D 21/02; B62D 21/09; B62D 21/11

(57) ABSTRACT

The revolutionary concept can be used on any caravan design or motorhome with slight alterations to the internal layout. The storage or other purpose unit serves as a windbreaker in the caravan design. Storage under the caravan or motorhome with the raised floor. The internal layout ideally will have a kitchen with island bench on the side that is opening FIG. 1. Where the opening is beside a bedroom ideally there will be a space at the end of the bed where a person can access the decking FIG. 3. All the wall materials are standard caravan materials which could be an aluminium or fibreglass sandwich and the decking material, internal wall when upright, will be a light Malibu or similar to give strength and durability. The two side walls are similar to gates with pin hinges. The decking wall will have stands that will support the deck to the ground being height adjustable. The caravan is fully operational without expanding the living areas or only expanding some of the area.

### BACKGROUND OF THE INVENTION

A caravan that increases its size, the present invention relates to a new way of building a caravan so that the owner can have more space. For caravan owners who want access to the outside environment without increasing the overall size of the van whilst towing.

More particularly the invention relates to the ability to swing out walls and fold up walls on a decking area and then having an awning that will make the area fully enclosed.

Caravan customisation is a fast growing area of interest for many retirees and holiday enthusiasts. This customisation of a caravan will allow for a larger area for recreational purposes and will be of great interest to all ages.

Recently, the development of extendable current caravans with a push out area in various sizes and shapes have been on the increase. However this can only give you a marginal larger area to use in the caravan. These areas are either a dining area or bedroom area larger with the slide out extension however these extension caravans suffer many drawbacks in that they only increase the size of the area by small amount and require regular servicing to make sure the sliding mechanism does not get caught or jammed. If a caravan is in any sort of damage that slide out area this becomes a real problem to repair. Another drawback of these extendable caravans is that they only create a small walking area where the position was extended. You don't really get a sense of an openness, an open area within the caravan after the extension, therefore a need exists for a caravan that can extend its size to almost double its original size in a low-cost and functional way. A caravan with an area can be used as a fully open semi enclosed or fully enclosed area for whatever purpose the owner wishes to use the area for example barbecue area living area dining area or an extension to the kitchen meals area or even a sleeping area.

### A BRIEF SUMMARY OF THE INVENTION AND ITS ADVANTAGES

A brief summary of the invention the present invention comprises of a way of lowering a caravan side wall to form a deck and sliding or swinging out to side walls to double, or triple if on both sides, the size of the caravan and then an awning or rigid roof that can make the area transform from an open decking area open to a fully or partially enclosed area.

The caravan side wall is lowered by to hinges at the base of the frame. The internal cladding of this wall is decking material so when it folds down who creates a deck area the two side walls are located directly behind this wall and can be swing out after the main decking wall has been lowered down. Hinged to that main decking wall is a front wall, once this one is swung up, the two side walls then swing around clip into the front wall making it solid and secure.

The original design can be in many sizes of caravan and the opening of the caravan does not necessarily have to be the full caravan side wall, it can be part of the side wall also the invention can be used to triple the size of a caravan by lowering both sides of the caravan and extending both sides of the caravan or the rear of the caravan and using the same methodology.

### A BRIEF DESCRIPTION OF THE DRAWINGS

The floor plan shows a very simple living area open kitchen and a bathroom. The layout comprising of shower kitchen and toilet with room at the rear of the caravan for a refrigerator and pantry FIG. 1. This layout of a simple 5150 mm version of the invention, one of the layouts that could be used.

FIG. 2 to illustrate the perspective view looking from the end of the caravan to show the height of the caravan and the openness of the floor area between the kitchen and bathroom. FIG. 2 swing out slide walls length are dependent on the height of the frame. The front wall height to be 1900 or higher allowing for the awning blind or rigid roof to have a slope for water run-off and yet still be at standing height inside the front wall.

FIG. 3 shows the side view of the caravan once the side deck wall is lowered, the two side walls/swing out walls to create an enclosed area and also shows the awning systems were that's positioned on the side of the caravan.

FIG. 4 is a side elevation to show the storage unit which acts as a windbreaker and can be used for hanging space and the storage under the caravan and the dimensions of the wall fold down for the decking.

FIG. 5 shows the storage areas and in particular the hanging space at the end of their caravan which is unique feature of this version of the design.

### DETAILED DESCRIPTION OF THE INVENTION

The detailed description of the invention the terminology used herein is the purpose of describing the particular features of the invention but not intended to limit the invention.

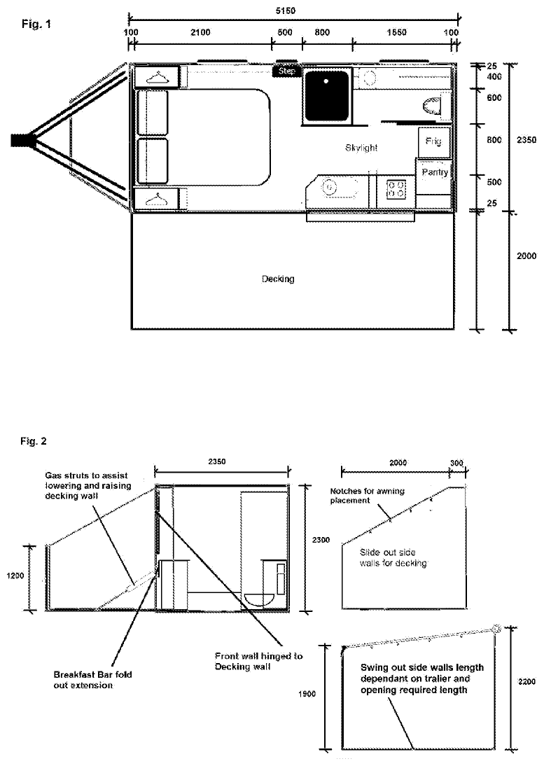

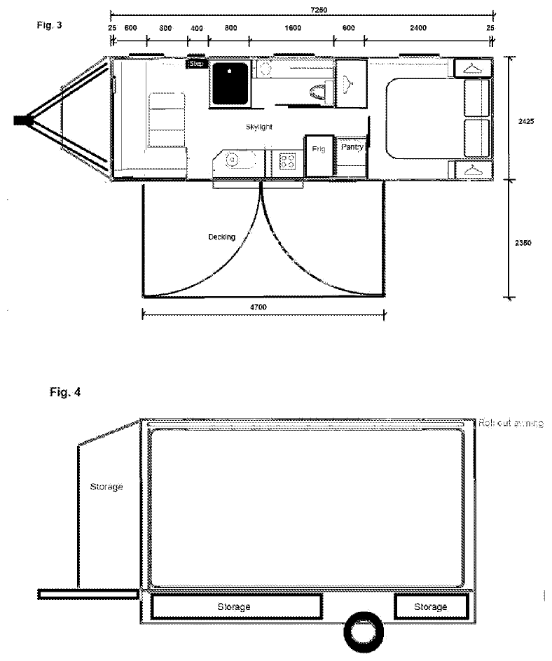

Related information of the wall drawing will have a hydraulic devices to enable the will to be lowered slowly and when then to help put the wall back into place the awning will have special positions on each wall notches and clip into as shown in FIG. 2.

The overall height of the caravan is higher than the standard caravan due to the higher floor height which enable storage underneath and all the electrical and plumbing to be run underneath the caravan to save money, as a cheaper manufacturing option and easier to service/maintain.

The special hinge system used to pivot the wall into the decking position is part of this invention and it allows the wall to be lowered and level with the caravan floor without any gaps. Gas struts or a coiled spring will assist in the lowering and raising of the decking wall.

FIG. 7 shows an alternative longer caravan model and a different layout using the same invention to increase the size of the overall caravan.

In FIG. 8 another layout of a 7250 mm van which shows that use of the invention that can make a larger area and key design changes in the layout.

FIG. 2 swing out/side walls length dependent on trailer opening required links with notches the front wall height to be 1900 allowing for the awning blind do have a slope for water run-off and yet still be at standing height 1900 mm inside the front wall.

FIG. 2 shows the notches for awning placement the awning can be placed at different extension lengths to let some light into the decking area or completely cover the decking area. FIG. 2 shows the shape of a slide out, side wall for the decking and also shows the dimensions for a swing outside wall design for the decking.

FIG. 3 shows the swing out, side wall system which increases the width of a caravan, an additional 75 mm increasing the overall width to 2425 millimetres.

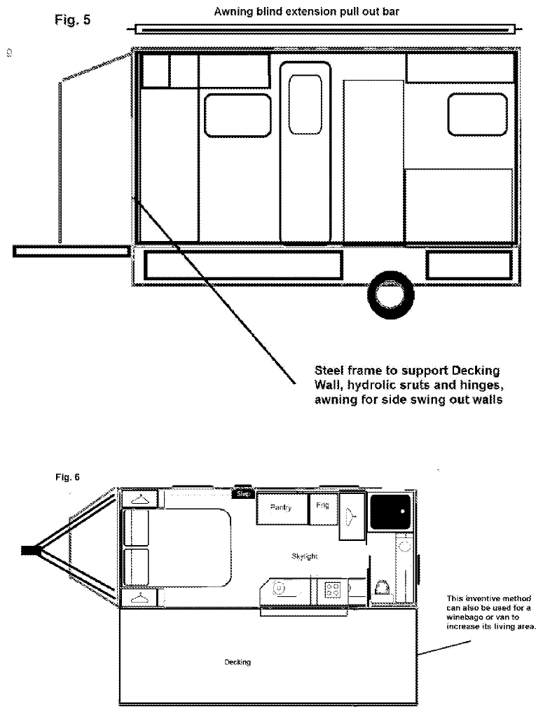

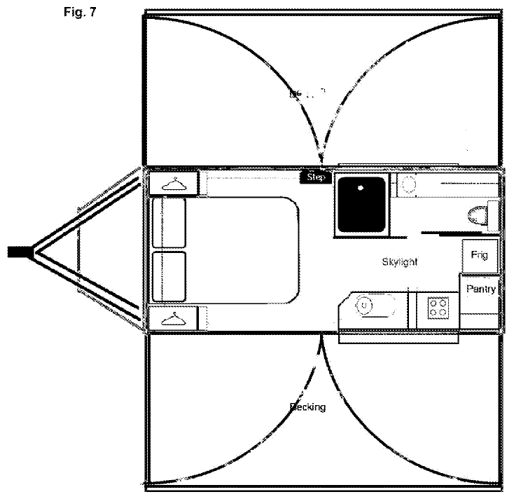

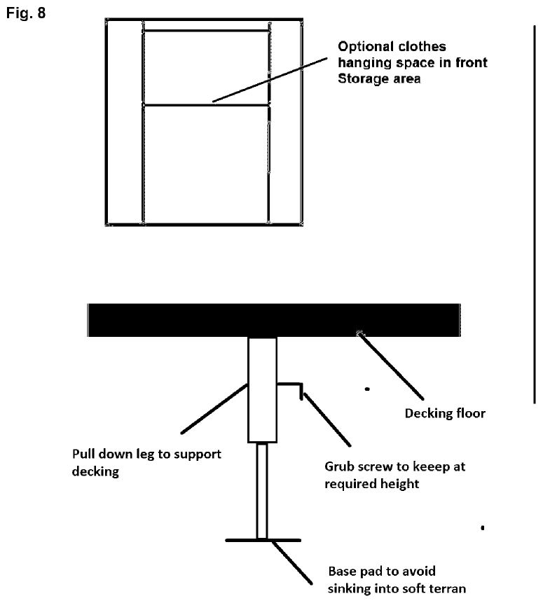

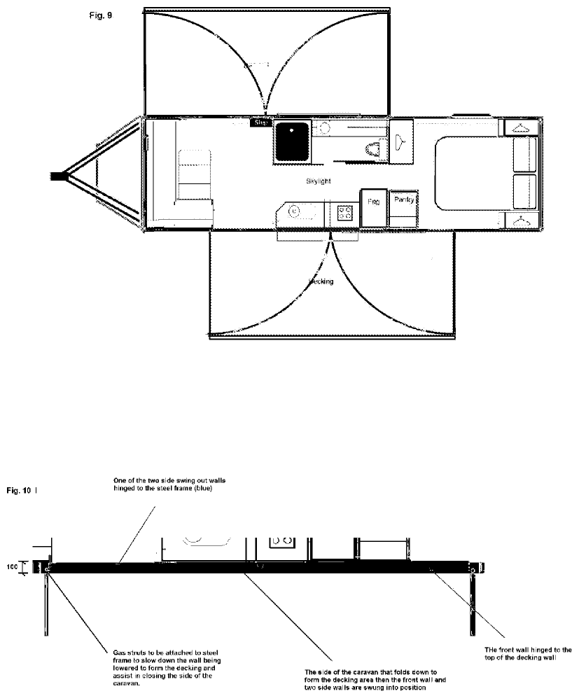

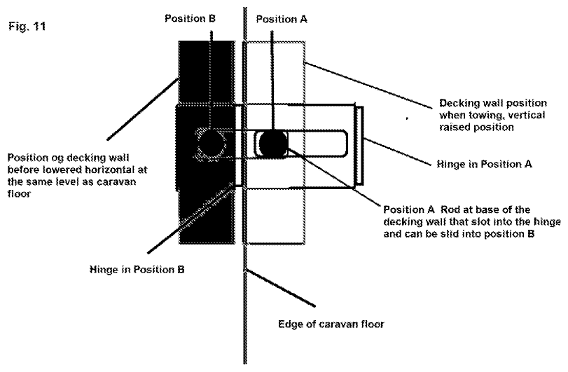

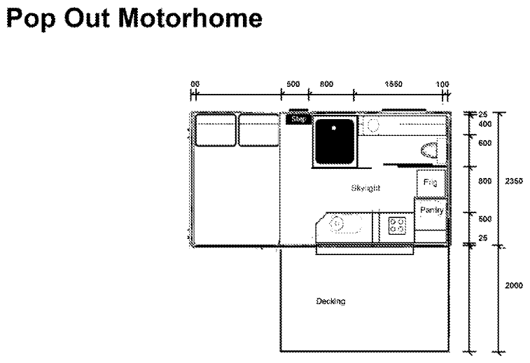

FIG. 5 shows the awning blind extension pull out bar with steel rod ends to fit into the sidewall notches. FIG. 5 shows the window and door layout as a cutaway view and also indicates the steel frame to support the decking wall and hydraulics struts and hinges.

FIG. 10 shows how the external decking wall has a folded front wall and behind this are two swing out/side walls to completely enclose the decking area. A detailed drawing showing the side walls and the front wall hinged to the side decking wall of the caravan how they sit together when the caravan is packed up ready to travel on the road total width of 100 to 250 mm depending on the number of components.

FIG. 6 shows a another layout with the bathroom at the end of the caravan and full decking folding down on one side of the van with sliding doors at both ends of the van to create the side walls for the decking.

FIG. 9 shows a simple layout of the van with decking folding out on both sides of the caravan to almost triple the usable space on both sides of the caravan, walls which swing out are used. FIG. 9 shows the opening for the decking can be on both sides of the caravan or even the end of the caravan situated at different positions using the same methodology of the walls which swing out forming to side walls on the decking with the front wall of the decking being hinged to the decking floor as shown in FIG. 2.

FIG. 8 shows an optional clothes hanging space for the front storage area.

1. The method of increasing a living area at a similar standing and walk around height, at substantially the same floor level throughout the living area of new or to be manufactured or used or retrofitted into existing a caravan, trailer, motorhome or campervan, the method comprising of:
providing a frame which is a full substantially square or rectangular frame, with four sides, two substantially horizontal and two substantially vertical;
providing the frame to structurally support, to enclose, accommodate and hinge a rigid decking, pivoting on a substantially horizontal axis from the base of the frame, with supporting legs;
providing the decking that becomes a side wall of one or both sides of the caravan body in the folded substantially vertical position;
positioning two rigid swing-out/side walls within the frame, swinging out over the decking area on hinges from the frame pivoting on a substantially vertical axis swinging out to each end of the decking area;
positioning a rigid front wall hinged to the front of the said rigid decking and swinging upward to a substantially vertical position;
providing the said frame and the said decking, when the said side wall of the caravan body within the frame is lowered creating the said deck, leaving an open area substantially the size and dimensions of the said frame, inserted, designed or built into new to be manufactured or used/existing caravans, trailers, motorhomes or campervans.

2. The method of claim 1 with a roof and floor completing the frame made of construction material engineered to support the weight of building materials used being all or some of these components: the decking, the side walls, the front wall, awning or rigid roof, the decking floor and decking leg supports are made from caravan construction materials used in building or modifying caravans, trailers, motorhomes or campervans.

3. The method of claim 1 wherein the frame structurally supports and accommodates: coil springs, special hinges, actuators, winches, motors, gas struts, hinges, winches to allow for ease of lowering, unfolding, raising the decking wall, side walls, front wall, leg supports for the deck.

4. The method of claim 1 wherein the said frame for new/to be manufactured or used or existing caravans, trailers, motorhome or campervans has one or more than one frame in each caravan, trailer, motorhome or campervan, the frames having all or some of the components and features listed in claim 2 and claim 3.

5. The method of claim 1 further providing a windbreaker, full height unit for storage or other purposes, at the front over the drawbar and the storage under the floor which is substantially the same level as the top of the wheel arches and the bottom of the said frame stores other equipment for personal requirements.

6. The method of claim 1 wherein the said supporting legs, the said decking frame and said deck floor has the strength to support the weight of people, furnishings and equipment in each additional living area.

7. An apparatus being a frame to increase a living area at a similar standing and walk around height, at substantially the same floor level throughout the living area of new/to be manufactured or used/retrofitted into existing a caravan, trailer, motorhome or campervan comprising of:
A frame which is a full substantially square or rectangular, with four sides, two substantially horizontal and two substantially vertical during manufacture or by adapting, strengthening an existing frame or built independently and inserted, attached into an existing caravan, trailer, campervan or motorhome.
The decking that becomes the only side wall of one or both sides of the caravan body in the folded substantially vertical position which when lowered becomes said decking or extended floor with supporting legs;
The said frame is to structurally support, to enclose, accommodate and hinge a rigid decking, pivoting on a substantially horizontal axis from the base of the frame, with supporting legs;
Two rigid side walls within the said frame, swinging out over the decking area on hinges from the said frame pivoting on a substantially vertical axis swinging out to each end of the decking area;
A rigid front wall is hinged to the front of the said rigid decking and swinging upward on a substantially horizontal axis to a substantially vertical position;
The said frame and the said decking, when the said side wall of the caravan body within the said frame is lowered creating the said deck, leaving an open area substantially the size and dimensions of the said frame, inserted, designed or built into new to be manufactured or used/existing caravans, trailers, motorhomes or campervans.

8. The said frame of claim 1 base is substantially horizontal, further providing storage under the floor which is substantially the same level as the top of the wheel arches and the bottom of the said frame, with a windbreaker, full height unit for storage or other purposes, at the front over the drawbar.

9. The apparatus includes supporting legs, the decking frame and flooring which has the strength to support the weight of people, furnishings and equipment in each additional living area.
